(19) United States
(12) Patent Application Publication
(10) Pub. No.: US 2024/0130405 A1
(43) Pub. Date: Apr. 25, 2024

(54) COMPOSITIONS OPACIFIED WITH SWEET FLOUR

(71) Applicant: CORN PRODUCTS DEVELOPMENT, INC., WESTCHESTER, IL (US)

(72) Inventors: Katelyn MEYLER, Bridgewater, NJ (US); Matt HENLEY, Bridgewater, NJ (US); Leslie DREW, Bridgewater, NJ (US); Adrianne SPERANZA, Bridgewater, NJ (US); Afaf MAKARIOUS, Bridgewater, NJ (US)

(21) Appl. No.: 18/546,816

(22) PCT Filed: Mar. 3, 2022
(86) PCT No.: PCT/US2022/018608

§ 371 Date: Aug. 16, 2023

Related U.S. Application Data
(60) Provisional application No. 63/156,733, filed on Mar. 4, 2021.

(51) Int. Cl. A23L 7/10; A23L 29/219

(52) U.S. Cl. CPC A23L 7/198; A23L 29/219

(57) ABSTRACT

This specification also discloses sweet flours and uses of sweet flours in compositions. In preferred embodiments the compositions are edible. In at some embodiments the sweet flour is used as an opacifier and can be used to replace common whitening agents such as titanium dioxide or calcium carbonate. Illustrative compositions are flowable or meltable and comprise a sweet flour in an amount a sweet flour in an amount of from about 1% to about 6% by weight of the composition.

This specification also discloses sweet flours and uses of sweet flours in compositions. In preferred embodiments the compositions are edible. In at some embodiments the sweet flour is used as an opacifier and can be used to replace common whitening agents such as titanium dioxide or calcium carbonate.

Opacifiers (which may be considered clouding agents, whitening agents, or lightening agents) are used in edible compositions. Particularly useful opacifiers are those able to provide opacity, or whitening, or lightening to flowable compositions such as beverages, sauces, gravies, yogurts, alternative yogurts, alternative dairy beverages, and non-dairy creamers where it is commonly for solid opacifiers to settle or otherwise have reduced opacifying effect. Regarding whitening or lightening effects, these can be observed relative to various colorimetry calculations such as by reference to a Hunter L where the whitening agent tends to increase the Hunter L value of a composition compare to the same composition but using an opacifier.

Although opacifiers exist on the market, for various reasons there remains a need for others. In some instances common opacifiers, like titanium dioxide and calcium carbonate, are viewed unfavorably by at least some consumers or regulatory bodies. In other instances formulators want to remove opacifiers, like milk solids or fat, to make certain dietary claims like vegan or low fat.

This specification describes sweet flours useful as opacifiers in compositions. In some embodiments, the sweet flours disclosed in this specification are used as opacifiers, including their effect as clouding agents, whitening agents, and lightening agents. In some embodiments it is used to replace common opacifiers in compositions, like titanium dioxide, calcium carbonate, fat or milk solids. In other embodiments, a composition made with sweet flour has a Hunter L values closer to the same edible composition made with milk solids, high fat content or titanium dioxide than does the edible composition made with another non-sweet flour or non-sweet starch. In some embodiments, the disclosed sweet flours are used as a clouding agent to replace the opacifying effect of milk solids, oils or titanium dioxide in a beverage or semi-transparent liquid.

The technology disclosed in this specification can be better understood with reference to the following the figure, which are not intended to limit the full scope of the technologies disclosed

### BRIEF DESCRIPTION OF THE FIGURES

FIG. 1 is a graph of the color profile of various bechamel-style sauces made with and without the sweet corn flours described in this specification.

FIG. 2 is a graph of the of various bechamel-style sauces made with and without the sweet corn flours described in this specification.

Compositions may be any composition where opacifiers, lightening agents or whitening agents are used. In preferred embodiments a composition is an edible composition. In some embodiments, sweet corn flour is used as a clouding agent or as a lightening agent in a flowable edible composition including but not limited to clouded beverages, sauces, gravies, yogurts, alternative yogurts, alternative dairy beverages, and non-dairy creamers. In still other embodiments described in this specification, sweet flours are used in a solid edible composition, including solid compositions that can melt (a meltable solid edible composition). In some embodiments, a sweet flour is used lighten, whiten, or opacify a meltable solid edible composition when the composition is melted. In other embodiments, a meltable solid edible composition is an imitation cheese, a vegan cheese analog, a frozen dessert, an ice cream, a dairy-free ice cream-analog, a frozen sauce. Meltable solid edible compositions, for example an imitation cheese, a vegan cheese analog, a frozen dessert, an ice cream, a dairy-free ice cream-analog, a frozen sauce, lose their color and opacity when they are melted. In embodiments, vegan analog cheese made using sweet flour have a Hunter L value more like vegan cheese made using titanium dioxide than using other non-sweet flour starches.

Within this specification the term “sweet flour” means flour obtained from an endosperm of a cereal, grain or kernel comprising a recessive sugary-1 gene, which can be abbreviated Su-1 as the dominant allele, and su-1 as the recessive allele. Although not intended to be limiting as to a source for sweet flour, a useful source for sweet flour is sweet corn. A sugary-1 recessive corn, called within this specification a sweet corn, is available as the silver queen variant of corn. The sugary-1 gene is known and its role in the biosynthesis of starch has been studied by others. (See e.g. James, M. G., et al, “Characterization of the maize gene sugary 1, a determinant of starch composition in kernels,” Plant Cell vol. 7, pp. 417-429 (1995).) The following is provided to further describe sweet flours but is not intended to limit the full understanding of the effect of a recessive sugary-1 gene in the starch biosynthesis pathway. The recessive sugary-1 gene interferes with the normal synthesis of starch forming starch polymers having substantially more alpha-1-6 linkages between glycosides than is common in amylopectin or amylose. These abnormal starch polymers do not form granules (as is common of amylose and amylopectin) and they are soluble in water without the further processing typically required to solubilize starch in water: in other words they are soluble without prior gelatinization of the starch granule.

Sweet flour, and sweet corn flour, may be obtained by milling sweet grains or sweet corn kernels to obtain flour. Sweet flour, like other flours, contains (among other things) polysaccharides, fibers, lipids, proteins, and ash. Sweet flour differs from most flours, however, by naturally having substantial soluble starch. Within this specification, sweet flour and sweet corn flour have enough protein to be classified as flour instead of starch. In the broadest sense sweet corn flours have at least 0.5% protein by weight (with reference to common corn starch) or at least about 1.0% protein by weight (with reference to high amylose corn starch). In preferred embodiments, sweet flours and sweet corn flours have protein content greater than about more than 5% protein in an unprocessed milled product or will have from 2% to 4% to protein in a clarified product.

In any embodiment described in this specification, sweet flour, preferably a sweet corn flour, comprises from 65% to 85% by weight soluble starch. In any embodiment described in this specification, sweet flour comprises at least about 5% (wt. %), or from about 5% to about 9% protein. In any embodiment described in this specification, sweet flour comprises from about 10% to about 30% granular starch (amylose and amylopectin) by weight of the flour, or about 13% to about 30% or about 20% to about 30%. Granular starch and protein are generally insoluble without further processing.

In any embodiment described in this specification, a sweet flour may be clarified to remove at least some protein and granular starch. In any embodiment described in this specification, a sweet flour may be clarified by filtration or centrifugation or other known to separate components of starch, soluble material, protein, etc., within a flour. Using centrifugation, for example, soluble components remain in the supernatant and can be poured from the insoluble components. In any embodiment a clarified sweet flour is not high pressure filtered (using for example, microfiltration, ultrafiltration, or reverse osmosis filtration) to obtain a more uniform composition.

In any embodiment described in this specification a clarified sweet flour or clarified sweet corn flour has a polydispersity index greater than 0.35, or greater than about 0.37, or from about 0.37 about 0.43. In any embodiment described in this specification the soluble starch within a clarified sweet flour or clarified sweet corn flour described in this specification has a polydispersity index greater than 0.35, or greater than about 0.37, or from about 0.37 about 0.43

In any embodiment a clarified sweet flour or clarified sweet corn has a mean particle size of from 100 to 200 nm or from 100 to 150 nm, or from 120 to 140 nm. In any embodiment the soluble starch in a clarified sweet flour or clarified sweet corn has a mean particle size of from 100 to 200 nm or from 100 to 150 nm, or from 120 to 140 nm. Polydispersity index and mean particle size can be measured in solution using dynamic light scattering.

In any embodiment described in this specification, clarified sweet flour comprises from about 80% to about 95% soluble starch. In any embodiment described in this specification, clarified sweet flour comprises from about 80% to about 90% soluble starch by weight of the flour. In any embodiment described in the specification, a clarified sweet flour is preferably a clarified sweet corn flour.

In any embodiment described in this specification, clarified sweet flour has sweet corn protein content in an amount greater than about 2% by weight of the flour. In any embodiment described in this specification, clarified sweet flour has sweet corn protein content in an amount from about 2% to about 4% by weight of the flour. In any embodiment described in this specification a clarified sweet flour has less insoluble starch content than sweet flour. In any embodiment a clarified sweet flour has insoluble starch content of less than about 5% by weight of the flour.

Any embodiment of sweet flour, or clarified sweet flour, or sweet corn flour, or clarified sweet corn flour described in this specification can be used to make edible compositions. In any embodiment described in this specification, an edible composition comprises a moisture content of at least about 30% by weight of the composition and a sweet flour in an amount of from about 1% to about 10% or from about 1% to about 5% by weight of the composition, or from about 2% to about 4% by weight of the composition. Edible compositions may be in solid form or in liquid form or are flowable or are meltable. In any embodiment of an edible composition described in this specification, sweet flour is used in an edible composition to replace titanium dioxide. In any embodiment of an edible composition described in this specification, sweet flour is used in an edible composition to increase the Hunter L value of the compositions.

Any embodiment of a sweet flour or clarified sweet flour or sweet corn flour or clarified sweet corn flour is gelatinized or pregelatinized for example using drum drying or spray cooking, or by other method.

Edible composition described in this specification may include other ingredients commonly used in edible compositions. In any embodiment described in this specification, an edible composition further comprises a starch not from the sweet flour in an amount greater than 1% by weight of the composition. Such starches may be selected from a group including but not limited to corn, waxy corn, tapioca, waxy tapioca, potato waxy potato, rice waxy rice, pea and mixtures thereof. Starches used in edible compositions may be native starches. Starches used in edible compositions may also be modified starch. Any food grade modified starch may be used in the edible compositions of this specification, including thermal inhibition, pregelatinization, acetylation, hydropropylation, oxidization, acid hydrolysis, enzyme hydrolysis and combinations thereof. Other useful modifications include crosslinking (chemical inhibition) and octenyl-succinic acid modifications.

In any embodiment, an edible composition as described in this specification further comprises a plant protein in an amount of greater than about 1% or from about 1% to about 20% by weight of the composition. In any embodiment described in this specification, an edible composition comprises a plant protein selected from the group consisting of pea, lentil, chickpea, fava bean, potato, quinoa and combinations thereof.

Other useful ingredients include hydrocolloids including gums (including but not limited to xanthan gum, gum acacia, locust bean gum) and gum like materials such carboxymethyl cellulose and hydroxypropyl methyl cellulose, fiber (including resistant starch or soluble fiber), pectin, flavorings, seasonings, acidulants, salts, preservatives, water and other aqueous ingredients, and colorings.

In embodiments an edible composition comprising soluble sweet flour is a flowable composition for example, but not limited to, a sauce or a gravy or a beverage or a non-dairy creamer. In any embodiment described in this specification, sweet flour is used in a flowable edible composition as whitening or lightening agent or clouding agent in a food composition. In any embodiment described in this specification a sweet flour is used in a flowable edible composition to increase the Hunter L value of a food composition compared to the food composition not comprising sweet flour or titanium dioxide. In any embodiment described in this specification, a flowable edible composition comprises a soluble starch in an amount of about from 0.70% to about 6% or about 1% to about 6%, or from about 1% to about 4% or from about 1.4% to about 3.8% or from about 1.9% to about 3.8% by weight of the composition, or from about 2% to about 6% or from about 3% to about 6%. In any embodiment described in this specification, a flowable edible composition comprises sweet protein, preferably sweet corn protein, in an amount of about 0.01% to about 1.0% or about 0.05% to about 0.6% or from about 0.05% to about 0.48% or about 0.05% to about 0.3% or from about 0.05% to about 0.2%.

In any embodiment described in this specification an edible composition comprising sweet flour is a meltable edible composition, meaning a composition that becomes flowable, or more flowable as it is heated. In any embodiment described in this specification a meltable edible composition has a moisture content of 30% to 60%, or 40% to 50% (by weight of the composition); and a sweet flour in an amount of from about 1% to about 10% or from about 1% to about 5% by weight of the composition, or from about 2% to about 4% (by weight of the composition). In any embodiment described in this specification, a meltable edible composition comprises a starch not from sweet flour in an amount of about 10% to about 35% or about 15% to about 35% or about 20% to about 35% or about 20% to about 30% (by weight of the composition). In any embodiment described in this specification, a meltable edible composition comprises a soluble starch in an amount of about from 0.70% to about 6% or from about 1% to about 6%, or from about 1% to about 4% or from about 1.4% to about 3.8% or from about 1.9% to about 3.8% by weight of the composition, or from about 2% to about 6%, or from about 3% to about 6%. In any embodiment described in this specification, a meltable edible composition comprises sweet corn protein in an amount of about 0.05% to about 0.6% or from about 0.05% to about 0.48% or about 0.05% to about 0.3% or from about 0.05% to about 0.2%.

In any embodiment a meltable composition is further comprises a starch not from sweet flour in an amount of about 10% to about 35% or about 15% to about 35% or about 20% to about 35% or about 20% to about 30% (by weight of the composition) wherein the starch is selected from the group consisting of waxy corn, waxy tapioca, waxy potato and mixtures thereof. In any embodiment of a meltable edible composition described in this specification, the non-sweet flour starch is a native starch. In any embodiment of a meltable composition described in this specification, the non-sweet flour starch is a modified starch, preferably wherein the modification is selected from the group consisting of thermal inhibition, chemical inhibition, pregelatinization, hydroxypropylation, acetylation, acid hydrolysis, enzymatic hydrolysis, oxidation, and mixtures thereof.

In any embodiment described in this specification, a meltable edible composition comprises a plant protein in an amount of about 5% to about 20% by weight of the composition, or from about 5% to about 15%, or from about 10% to about 15%. In an embodiment of a meltable edible composition comprises a plant protein selected from the group consisting of pea, lentil, chickpea, fava bean, potato, quinoa and combinations thereof.

In any embodiment described in this specification an edible composition comprising a sweet flour is a meltable edible composition. In any composition an meltable edible composition comprising a sweet flour has a melt spread when heated at about 232° C. for five minutes of at least about 25%, or from about 25% to about 60%. In any embodiment describe in this specification a meltable edible, a sweet flour is used to increase the Hunter L value of the composition in the melted phase compared to the composition not comprising sweet corn flour or titanium dioxide.

In any embodiment described in this specification a melted meltable edible composition is an imitation cheese, a vegan cheese analog, a frozen dessert, an ice cream, a dairy-free ice cream-analog, a frozen sauce. In any embodiment described in this specification a meltable edible composition has a casein content less than about 20% or less than about 15% or less than about 10% or having no added casein. It is observed that as meltable food composition melts the become more transparent. In any embodiment escribed in this specification, a sweet flour or sweet corn flour (whether clarified) is used to reduce the drop in Hunter L value observed when a meltable edible composition is melted. In any embodiment described in this specification, a meltable edible composition has a Hunter L value of greater than about 55 or from about 55 to about 70 or from about 60 to about 70 when the composition is melted.

Within this specification the term “sweet flour” means flour obtained from an endosperm of a cereal, grain or kernel comprising a recessive sugary-1 gene, which can be abbreviated Su-1 as the dominant allele, and su-1 as the recessive allele. Although not intended to be limiting as to a source for sweet flour, a useful source for sweet flour is sweet corn. A sugary-1 recessive corn, called within this specification a sweet corn, is available as the silver queen variant of corn. The sugary-1 gene is known and its role in the biosynthesis of starch has been studied by others. (See e.g. James, M. G., et al, “Characterization of the maize gene sugary 1, a determinant of starch composition in kernels,” Plant Cell vol. 7, pp. 417-429 (1995).) The following is provided to further describe sweet flours but is not intended to limit the full understanding of the effect of a recessive sugary-1 gene in the starch biosynthesis pathway. The recessive sugary-1 gene interferes with the normal synthesis of starch. With reference to sweet corn, a significant portion of the starch in sweet corn kernel (sometimes greater 65%) has a chemical structure wherein starch polymers have substantially more alpha-1-6 linkages between glycosides than is common in amylopectin or amylose. These abnormal starch polymers do not form granules (as is common of amylose and amylopectin) and they are soluble in water without the further processing typically required to solubilize starch in water: in other words they are soluble without prior gelatinization of the starch granule.

Within this specification, “clarified sweet flour” refers to a sweet flour that has been processed to remove at least some of the protein and insoluble starch from the composition. Clarified sweet flour is a subset of sweet flour and reference to sweet flour includes clarified sweet flour unless clear from the context to be limited to one of clarified sweet flour and sweet flour. Similarly, sweet corn flour includes clarified sweet corn flour unless limited by context. All embodiments in this specification made using sweet flour or sweet corn flour may also be made using clarified sweet flour or clarified sweet corn flour.

Within this specification, “soluble starch” refers to starch that is soluble without having be subjected to a process using heat and moisture to disrupt the granular structure of starch (called gelatinization). Soluble starch, as used in this specification is starch that is soluble and is obtained from the endosperm of a cereal, grain, or kernel (including for example but not limited to a sweet corn kernel) having a recessive sugary-1 gene. Soluble starch has substantially more alpha-1-6 linkages between glycosides than is common in amylopectin or amylose. The increased alpha 1-6 linkages of soluble starch make soluble starch distinguishable from gelatinized amylose or amylopectin starch: gelatinized amylose and amylopectin are not within the definition of “soluble starch” as that term is use in this specification. In comparison, insoluble starch refers to starch that requires gelatinization before it will dissolve in an aqueous solution, or to starch that does not dissolve in an aqueous solution at all.

Within this specification, “native starch” refers to a starch (soluble or insoluble) that has not been modified chemically, enzymatically or physically.

Within this specification, “thermally inhibited” starch refers to starch that is heat treated in a substantially anhydrous state (less than 2% moisture) to modify the starch so that it functions like a chemically crosslinked (i.e. chemically inhibited starch). Useful methods for thermally inhibiting starch are described in WO 95-04082, which is incorporated herein in its entirety.

Within this specification, “gelatinized” and “pregelatinized” with reference to starches and flours are known terms in the art and have their full meaning within the art. Within this specification gelatinized and pregelatinized starches and flours are not within the definition of native starch or flour.

Within this specification, “imitation cheese” refers to a cheese-like composition that include ingredients in place of or in addition to milk. Such replacement ingredients include, but are not limited to, casein, starch (or modified starch), sweet flour.

Within this specification, “vegan analog cheese” refers to a variety of imitation cheese that comprises no animal-based protein.

Within this specification, “% melt spread” refers to the percent change in diameter between original and heated samples of a composition using the following test. Samples (cylindrical, 39.5 mm diameter, 5 mm thickness) are heated in oven safe dish for five minutes in an oven preheated to 450° F. (232° C.). Samples were cooled for 5 minutes and the diameter of the sample is measured again.

Use of “about” to modify a number is meant to include the number recited plus or minus 10%. Where legally permissible recitation of a value in a claim means about the value. Use of about in a claim or in the specification is not intended to limit the full scope of covered equivalents.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The technology disclosed in this specification can be further understood by reference to the following non-limiting aspects.

1. A sweet flour comprising: soluble starch in an amount of at least about 65% or at least about 85%, wherein preferably the sweet flour is a sweet corn flour.

2. The sweet flour of claim 1 having a protein content in an amount greater than about 0.5% by weight of the flour, or greater than about 1% or, greater than about 2% or greater than about 5%, or from about 5% to about 9% by weight of the flour.

3. The sweet flour of claim 1 or 2 having an insoluble starch content of less than about 5% by weight of the flour.

4. The sweet flour of any one of claims 1 to 3 having a mean particle size of a particle size distribution of from 100 to 200 nm or from 100 to 150 nm, or from 120 to 140 nm.

5. The sweet flour of any one of claims 1 to 4 and having a polydispersity index greater than 0.35, or greater than about 0.37, or from about 0.37 about 0.43.

6. The sweet flour of any one of claims 1 to 5 being a sweet flour, preferably a sweet corn flour, wherein the flour is a clarified sweet corn flour having a protein content in an amount greater than about 2% by weight of the flour, or from about 2% to about 4% by weight of the flour.

7. The sweet flour or any one of claims 1 to 6 wherein the sweet flour is pregelatinized, wherein optionally, the sweet flour is pregelatinized by spray cooking or by drum drying.

8. A composition comprising: a moisture content of at least about 30% by weight of the composition; and a sweet flour in an amount of from about 1% to about 6% by weight of the composition, or from about 2% to about 6, or 3% to 6% by weight of the composition.

9. The composition of claim 8 wherein the sweet flour is selected from the group consisting of clarified sweet flour, sweet corn flour, and clarified sweet corn flour.

10. The composition of claim 8 or 9 wherein the sweet flour is clarified sweet corn flour.

11. The composition of any one of claims 8 to 10 further comprising a starch from a source other than sweet flour, the starch being in an amount greater than 1% by weight of the composition.

12. The composition of any one of claims 8 to 11 wherein the composition has a starch from a source other than sweet flour, the starch being in an amount of about 1% to about 10% or about 1% to about 5%, or about 1% to about 3% (wt. % of the composition).

13. The composition of any one of claims 8 to 12 further comprising a starch from a source other than sweet flour, the starch being in an amount of about 10% to about 35% or about 15% to about 35% or about 20% to about 35% or about 20% to about 30% (by weight of the composition).

14. The composition of any one of claims 8 to 13 further comprising a starch from a source other than sweet flour, wherein the starch is from a source selected from the group consisting of: corn, waxy corn, tapioca, waxy tapioca, potato waxy potato, rice waxy rice, pea and mixtures thereof.

15. The composition of any one of claims 8 to 14 wherein the starch from a than sweet flour is a native starch.

16. The composition of any one of claims 8 to 15 wherein the starch from a source other than sweet flour is a modified starch; wherein, optionally, the modification is selected from the group consisting of thermal inhibition, chemical inhibition, pregelatinization, acetylation, hydropropylation, oxidation, acid hydrolysis, enzyme hydrolysis and combinations thereof.

17. The composition of any one of claims 8 to 16 wherein the composition comprises a soluble starch in an amount of about from 0.70% to about 6% or about 1% to about 6%, or from about 1% to about 4% or from about 1.4% to about 3.8% or from about 1.9% to about 3.8% by weight of the composition, or from about 2% to about 6% or from about 3% to about 6%.

18. The composition of any one of claims 8 to 17 wherein the composition comprises sweet corn protein in an amount of about 0.01% to 1% about 0.05% to about 0.6% or from about 0.05% to about 0.48% or about 0.05% to about 0.3% or from about 0.05% to about 0.2%.

19. The composition of any one of claims 8 to 18 wherein the moisture content is greater than about 60%, or greater than about 75% or greater than about 80%, or greater than about 85% by weight of the composition.

20. The composition of any one of claims 8 to 19 wherein the having a Hunter L value of at least about 30 or at least about 35 or at least about 40 or at least about 50.

21. The composition of ay one claims 8 to 20 being a flowable composition.

22. The composition of claims 8 to 21 wherein the composition is selected from the group consisting of beverages, sauces, gravies, and non-dairy creamers.

23. The composition of any one of claims 8 to 22 the moisture content of 30% to 60%, or 40% to 50% (by weight of the composition).

24. The composition of any one of claims 8 to 23 further comprising a plant protein from a source other than sweet flour, wherein, optionally, the plant protein is from a source selected from the group consisting of: pea, lentil, chickpea, fava bean, potato, quinoa and combinations thereof.

25. The composition of any one of claims 8 to 24 further comprising a plant protein from a source other than sweet flour, wherein the protein is in an amount from about 5% to about 20% by weight of the composition, or from about 5% to about 15%, or from about 10% to about 15%.

26. The composition of any one of claims 8 to 25 being a meltable composition.

27. The composition of any one of claims 8 to 26 wherein the composition has a % melt spread of at least about 25%, or from 25% to 60%.

28 The composition of any one of claims 8 to 27 wherein the composition has a Hunter L value of greater than about 55 or from about 55 to about 70 or from about 60 to about 70 when melted.

29. The composition of any one of claims 8 to 28 being an imitation cheese or a vegan analog cheese.

30. The composition of any one of claims 8 to 29 having a casein content less than about 20% or less than about 15% or less than about 10% or having no added casein.

31. The edible composition of any one of claims 8 to 30 wherein the composition does not comprise titanium dioxide or calcium carbonate.

32. An edible composition comprising: a moisture content of at least about 30% by weight of the composition; and a sweet flour in an amount of from about 1% to about 6% by weight of the composition, or from about 2% to about 6, or 3% to 6% by weight of the composition.

33. The edible composition of claim 32 wherein the sweet flour is selected from the group consisting of clarified sweet flour, sweet corn flour, and clarified sweet corn flour.

34. The edible composition of claim 32 or 33 wherein the sweet flour is clarified sweet corn flour.

35. The edible composition of any one of claims 32 to 34 further comprising a starch from a source other than sweet flour, the starch being in an amount greater than 1% by weight of the composition.

36. The edible composition of any one of claims 32 to 35 wherein the composition has a starch from a source other than sweet flour, the starch being in an amount of about 1% to about 10% or about 1% to about 5%, or about 1% to about 3% (wt. % of the composition).

37. The edible composition of any one of claims 32 to 36 further comprising a starch from a source other than sweet flour, the starch being in an amount of about 10% to about 35% or about 15% to about 35% or about 20% to about 35% or about 20% to about 30% (by weight of the composition).

38. The edible composition of any one of claims 32 to 37 further comprising a starch from a source other than sweet flour, wherein the starch is from a source selected from the group consisting of: corn, waxy corn, tapioca, waxy tapioca, potato waxy potato, rice waxy rice, pea and mixtures thereof.

39 The edible composition of any one of claims 32 to 38 wherein the starch from a source other than sweet flour is a native starch.

40. The edible composition of any one of claims 32 to 39 wherein the starch from a source other than sweet flour is a modified starch, wherein, optionally, the modification is selected from the group consisting of thermal inhibition, chemical inhibition, pregelatinization, acetylation, hydropropylation, oxidation, acid hydrolysis, enzyme hydrolysis and combinations thereof.

41. The edible composition of any one of claims 32 to 40 wherein the composition comprises a soluble starch in an amount of about from 0.70% to about 6% or about 1% to about 6%, or from about 1% to about 4% or from about 1.4% to about 3.8% or from about 1.9% to about 3.8% by weight of the composition, or from about 2% to about 6% or from about 3% to about 6%.

42. The edible composition of any one of claims 32 to 41 wherein the composition comprises sweet corn protein in an amount of about 0.01% to 1% about 0.05% to about 0.6% or from about 0.05% to about 0.48% or about 0.05% to about 0.3% or from about 0.05% to about 0.2%.

43. The edible composition of any one of claims 32 to 42 wherein the moisture content is greater than about 60%, or greater than about 75% or greater than about 80%, or greater than about 85% by weight of the composition.

44. The edible composition of any one of claims 32 to 43 wherein the having a Hunter L value of at least about 30 or at least about 35 or at least about 40 or at least about 50.

45. The edible composition of ay one claims 32 to 44 being a flowable composition.

46. The edible composition of claims 32 to 45 wherein the composition is selected from the group consisting of beverages, sauces, gravies, and non-dairy creamers.

47. The edible composition of any one of claims 32 to 46 the moisture content of 30% to 60%, or 40% to 50% (by weight of the composition

48. The edible composition of any one of claims 32 to 47 further comprising a plant protein from a source other than sweet flour, wherein, optionally, the plant protein is from a source selected from the group consisting of: pea, lentil, chickpea, fava bean, potato, quinoa and combinations thereof.

49. The edible composition of any one of claims 32 to 48 further comprising a plant protein from a source other than sweet flour, the plant protein being in an amount from about 5% to about 20% by weight of the composition, or from about 5% to about 15%, or from about 10% to about 15%.

50. The edible composition of any one of claims 32 to 49 being a meltable composition.

52. The edible composition of any one of claims 32 to 50 wherein the composition has a % melt spread of at least about 25%, or from 25% to 60%.

52. The edible composition of any one of claims 32 to 51 wherein the composition has a Hunter L value of greater than about 55 or from about 55 to about 70 or from about 60 to about 70 when melted.

53. The edible composition of any one of claims 32 to 52 being an imitation cheese or a vegan analog cheese.

54. The edible composition of any one of claims 32 to 53 having a casein content less than about 20% or less than about 15% or less than about 10% or having no added casein.

55. The edible composition of any one of claims 32 to 53 wherein the composition does not comprise titanium dioxide or calcium carbonate.

56. A flowable edible composition comprising: a moisture content greater than about 60%, or greater than about 75% or greater than about 80%, or greater than about 85% by weight of the composition; and a sweet flour in an amount of from about 1% to about 6% by weight of the composition, or from about 2% to about 6, or 3% to 6% by weight of the composition.

57. The flowable composition of claim 56 wherein the composition has a starch not from the sweet flour, the starch being in an amount of about 1% to about 10% or about 1% to about 5%, or about 1% to about 3% (wt. % of the composition); wherein the starch is either (i) a native starch, or (ii) is a modified starch, wherein the modification is selected from the group consisting of pregelatinization, thermal inhibition, chemical inhibition, acetylation, hydropropylation, oxidization, acid hydrolysis, enzyme hydrolysis and combinations thereof.

58. The flowable composition of claim 56 or 57 wherein the composition comprises a soluble starch in an amount of about from 0.70% to about 6% or about 1% to about 6%, or from about 1% to about 4% or from about 1.4% to about 3.8% or from about 1.9% to about 3.8% by weight of the composition, or from about 2% to about 6% or from about 3% to about 6%.

59. The flowable composition of any one of claims 56 to 58 wherein the composition comprises sweet corn protein in an amount of about 0.01% to 1% about 0.05% to about 0.6% or from about 0.05% to about 0.48% or about 0.05% to about 0.3% or from about 0.05% to about 0.2%.

60. The flowable composition of any one of claims 56 to 59 wherein the sweet flour is selected from the group consisting of clarified sweet flour, sweet corn flour, and clarified sweet corn flour.

61. The flowable composition of any one of claims 56 to 60 wherein the sweet flour is clarified sweet corn flour.

62. The flowable composition of claims 56 to 61 wherein the composition is selected from the group consisting of beverages, sauces, gravies, and non-dairy creamers.

63. The flowable composition of any one of claims 56 to 62 wherein the having a Hunter L value of at least about 30 or at least about 35 or at least about 40 or at least about 50.

64. The flowable composition of any one of claims 56 to 64 wherein the composition does not comprise titanium dioxide or calcium carbonate.

65. A meltable edible composition comprising: a moisture content of 30% to 60%, or 40% to 50% (by weight of the composition; and a sweet flour in an amount of from about 1% to about 6% by weight of the composition, or from about 2% to about 6, or 3% to 6% by weight of the composition.

66. The meltable edible composition of claim 65 further comprising a starch from a source other than sweet flour, the starch being in an amount of about 10% to about 35% or about 15% to about 35% or about 20% to about 35% or about 20% to about 30% (by weight of the composition).

67. The meltable edible composition of claim 65 or 66 further comprising a starch from a source other than sweet corn wherein the starch is either (i) a native starch, or (ii) is a modified starch, wherein the modification is selected from the group consisting of thermal inhibition, pregelatinization, chemical inhibition, acetylation, hydropropylation, oxidization, acid hydrolysis, enzyme hydrolysis and combinations thereof.

68. The meltable edible composition any one of claims 65 to 68 wherein the starch from a source other than sweet corn flour is a native starch.

69. The meltable edible composition of any one of claims 65 to 69 wherein the composition comprises sweet corn protein in an amount of about 0.01% to 1% about 0.05% to about 0.6% or from about 0.05% to about 0.48% or about 0.05% to about 0.3% or from about 0.05% to about 0.2%.

70. The edible composition of any one of claims 65 to 69 wherein the moisture content is greater than about 60%, or greater than about 75% or greater than about 80%, or greater than about 85% by weight of the composition.

71. The meltable edible composition of any one of claims 65 to 70 wherein the sweet flour wherein the sweet flour is selected from the group consisting of clarified sweet flour, sweet corn flour, and clarified sweet corn flour,

72. The meltable edible composition of any one of claims 65 to 71 wherein the sweet flour is clarified sweet corn flour.

73. The meltable edible composition of any one of claims 65 to 72 wherein the starch from a source other that sweet flour is from a source selected from the group consisting of: waxy starch optionally wherein the starch is selected from the group consisting of waxy corn, waxy tapioca, waxy potato and mixtures thereof.

74. The meltable edible composition of any one of claims 65 to 73 further comprising a plant protein from a source other than sweet flour, wherein, optionally, the plant protein is from a source selected from the group consisting of: pea, lentil, chickpea, fava bean, potato, quinoa and combinations thereof.

75. The meltable composition of any one of claims 65 to 74 further comprising a protein content of from about 5% to about 20% by weight of the composition, or from about 5% to about 15%, or from about 10% to about 15%.

76. The meltable composition of any one of claims 65 to 75 wherein the composition has a % melt spread of at least about 25%, or from 25% to 60%.

77. The meltable composition of any one of claims 65 to 76 wherein the composition has a Hunter L value of greater than about 55 or from about 55 to about 70 or from about 60 to about 70 when melted.

78. The meltable composition of any one of claims 65 to 77 being an imitation cheese or a vegan analog cheese.

79. The meltable composition of any one of claims 65 to 78 having a casein content less than about 20% or less than about 15% or less than about 10% or having no added casein.

80. The meltable composition of any one of claims 56 to 64 wherein the composition does not comprise titanium dioxide or calcium carbonate.

81. Use of a sweet flour or sweet corn flour as described in any one of claims 1 to 8 in a manner as described in any foregoing claim.

82. A method of making a composition comprising: mixing a sweet flour as described in any forging claim and a second ingredient wherein preferably the sweet flour is a sweet corn flour; and wherein, preferably, the composition is an edible composition.

83. A pregelatinized sweet flour comprising: soluble starch in an amount of at least about 65% or from about 65% to about 85% wherein preferably the sweet flour is a sweet corn flour.

84. The sweet flour of claim 83 having a protein content of at least about from about 5%, or from about 5% to about 9% by weight of the flour.

85. The sweet flour of claim 83 or 84 having an insoluble starch content of less than about 5% by weight of the flour.

85. The sweet flour of any one of claims 83 to 85 having a mean particle size of a particle size distribution of from 100 to 200 nm or from 100 to 150 nm, or from 120 to 140 nm.

86. The sweet flour of any one of claims 83 to 86 and having a polydispersity index greater than 0.35, or greater than about 0.37, or from about 0.37 about 0.43.

87. A composition comprising: a) a moisture content of at least about 30% by weight of the composition; and b) a sweet flour in an amount of from about 1% to about 6% by weight of the composition, or from about 2% to about 6, or 3% to 6% by weight of the composition wherein, preferably, the sweet flour is a sweet corn flour and wherein, optionally the moisture content is in a range selected from the group consisting of i) of 30% to 60%, or 40% to 50% (by weight of the composition) and ii) greater than about 60%, or greater than about 75% or greater than about 80%, or greater than about 85% by weight of the composition.

88. The composition of claim 87 wherein the sweet flour is clarified sweet corn flour.

89. The composition of any one of claim 87 or 88 further comprising a second starch, which is from a source other than sweet flour wherein the second starch is in an amount greater than 1% by weight of the composition, or in an amount in a range selected from the group consisting of a) about 1% to about 10% or about 1% to about 5%, or about 1% to about 3% (wt. % of the composition); and v0 of about 10% to about 35% or about 15% to about 35% or about 20% to about 35% or about 20% to about 30% (by weight of the composition) wherein, optionally, the second starch is from a source selected from the group consisting of: corn, waxy corn, tapioca, waxy tapioca, potato waxy potato, rice waxy rice, pea and mixtures thereof.

90. The composition of any one of claims 87 to 89 wherein the having a Hunter L value of at least about 30 or at least about 35 or at least about 40 or at least about 50 or at least about 55 or from about 55 to about 70 or from about 60 to about 70.

91. The composition of any one of claims 87 to 90 further comprising a second plant, which is from a source other than sweet flour, in an amount from about 5% to about 20% by weight of the composition, or from about 5% to about 15%, or from about 10% to about 15% wherein, optionally, the second protein is a plant protein wherein optionally, the second protein is a is from a source selected from the group consisting of: pea, lentil, chickpea, fava bean, potato, quinoa, and combinations thereof.

92. The composition of any one of claims 87 to 91 wherein the composition does not comprise titanium dioxide or calcium carbonate.

93 The composition any one of claims 87 to 92 wherein the composition is selected from the group consisting of: imitation cheese, a vegan cheese analog, a frozen dessert, an ice cream, a dairy-free ice cream-analog, a frozen sauce, beverages, sauces, gravies, yogurts, alternative yogurts, alternative dairy beverages, and non-dairy creamers.

94. A flowable edible composition comprising: a) a moisture content greater than about 60%, or greater than about 75% or greater than about 80%, or greater than about 85% by weight of the composition; and b) a sweet flour in an amount of from about 1% to about 6% by weight of the composition, or from about 2% to about 6, or 3% to 6% by weight of the composition wherein, optionally, the sweet flour is a sweet corn flour.

95. The flowable composition of claim 94 wherein the composition further comprises a second starch, which is not from the sweet flour, and wherein the starch is in an amount of about 1% to about 10% or about 1% to about 5%, or about 1% to about 3% (wt. % of the composition) wherein, optionally, wherein, optionally, the second starch is from a source selected from the group consisting of: waxy starch optionally wherein the starch is selected from the group consisting of waxy corn, waxy tapioca, waxy potato and mixtures thereof.

96. The flowable composition of claim 94 or 95 wherein the starch is a native starch

97 The flowable composition of any one of claims 94 to 96 wherein the second starch is a modified starch, wherein, optionally, the modification is selected from the group consisting of pregelatinization, thermal inhibition, chemical inhibition, acetylation, hydropropylation, oxidization, acid hydrolysis, enzyme hydrolysis and combinations thereof.

98. The flowable composition of any one of claims 94 to 97 wherein the sweet flour is clarified sweet corn flour.

99. The flowable composition of claims 94 to 98 wherein the composition is selected from the group consisting of beverages, sauces, gravies, yogurts, alternative yogurts, alternative dairy beverages, and non-dairy creamers.

100. The flowable composition of any one of claims 94 to 99 wherein the having a Hunter L value of at least about 30 or at least about 35 or at least about 40 or at least about 50.

101. The flowable composition of any one of claims 94 to 100 wherein the composition does not comprise titanium dioxide or calcium carbonate.

102. A meltable edible composition comprising: a) a moisture content of 30% to 60%, or 40% to 50% (by weight of the composition; and b) a sweet flour in an amount of from about 1% to about 6% by weight of the composition, or from about 2% to about 6, or 3% to 6% by weight of the composition wherein, optionally, the sweet flour is a sweet corn flour.

103. The meltable edible composition of claim 102 further comprising a second starch, which is from a source other than sweet flour, wherein the second starch is in an amount of about 10% to about 35% or about 15% to about 35% or about 20% to about 35% or about 20% to about 30% (by weight of the composition) wherein, optionally, the second starch is from a source selected from the group consisting of: waxy starch optionally wherein the starch is selected from the group consisting of waxy corn, waxy tapioca, waxy potato and mixtures thereof.

104. The meltable edible composition of claim 102 or 103 wherein the second starch is a modified starch, wherein, optionally, the modification is selected from the group consisting of thermal inhibition, pregelatinization, chemical inhibition, acetylation, hydropropylation, oxidization, acid hydrolysis, enzyme hydrolysis and combinations thereof.

105. The meltable edible composition any one of claims 102 to 104 wherein the second starch is a native starch.

106. The meltable edible composition of any one of claims 102 to 105 further comprising wherein, optionally, a second protein, which is from a different source than the sweet flour, and wherein the protein is in an amount from about 5% to about 20% by weight of the composition, or from about 5% to about 15%, or from about 10% to about 15%. wherein, optionally, the second protein is a plant protein wherein, optionally, the second protein is from a source selected from the group consisting of: pea, lentil, chickpea, fava bean, potato, quinoa and combinations thereof.

107. The meltable composition of any one of claims 102 to 106 wherein the composition has a % melt spread of at least about 25%, or from 25% to 60%.

108. The meltable composition of any one of claims 102 to 107 wherein the composition has a Hunter L value of greater than about 55 or from about 55 to about 70 or from about 60 to about 70 when melted.

109. The meltable composition of any one of claims 102 to 108 wherein the composition is selected from the group consisting of an imitation cheese, a vegan cheese analog, a frozen dessert, an ice cream, a dairy-free ice cream-analog, a frozen sauce.

110. The meltable composition of any one of claims 102 to 109 wherein the composition does not comprise titanium dioxide or calcium carbonate.

111. Use of a sweet flour provide opacity to a composition as described in any foregoing claim and wherein, optionally, sweet flour is a sweet corn flour or a clarified sweet corn flour

112. A method of making a composition comprising: mixing a sweet flour and a second ingredient wherein, optionally, the sweet flour is a sweet corn flour or a clarified sweet corn flour wherein, optionally, the composition is a composition as described in any foregoing claim

The technology disclosed in this specification can be better understood with reference to the following examples which are provided for illustrative purposes and do not limit the full scope of the technology in any way.

### Example 1—Varying Amounts of Sweet Corn Flour in Brown Gravy as a TiO₂ Replacement

Applicants evaluated the effectiveness of sweet corn flour as a replacement for titanium dioxide (“TiO₂”) in brown gravy. Table 1 reports the formulations tested.

TABLE 1
Brown Gravy Formulations (Varying Sweet Corn Flour)

| | Sample 1 | Sample 2 | Sample 3 | Sample 4 | Sample 5 |
|---|---|---|---|---|---|
| INGREDIENTS | wt. % | wt. % | wt. % | wt. % | wt. % |
| Beef broth* | 66.0 | 66.0 | 66.0 | 66.0 | 66.0 |
| TiO₂ (10% | 0.15 | | | | |
| solution) | | | | | |
| Inhibited Starch | 4.0 | 4.0 | 4.0 | 4.0 | 4.0 |
| Extra fine sugar | 1.0 | 1.0 | 1.0 | 1.0 | 1.0 |
| Powdered Beef | 2.0 | 2.0 | 2.0 | 2.0 | 2.0 |
| Flavor | | | | | |
| Caramel Color | 0.4 | 0.4 | 0.4 | 0.4 | 0.4 |
| Onion Powder | 0.25 | 0.25 | 0.25 | 0.25 | 0.25 |
| Paprika | 0.2 | 0.2 | 0.2 | 0.2 | 0.2 |
| Sweet Corn | | | 1.0 (added | 3.0 (added | 3.0 (added |
| Flour | | | to dry) | to dry) | to wet) |
| Water | 25.0 | 25.15 | 24.15 | 22.15 | 22.15 |
| Butter | 1.0 | 1.0 | 1.0 | 1.0 | 1.0 |
| | 100 | 100 | 100 | 100 | 100 |

Gravy was made by first mixing titanium dioxide in beef broth until dispersed. Starch, sugar, beef flavor, onion powder, paprika, caramel color and sweet corn flour (in samples where it was used) were mixed together and then mixed with water until dispersed. Broth was added to the dispersed mixture of water and dry ingredients, which were cooked at 190° to 195° C. (several minutes). Butter was then added to the cooked mixture and the all ingredients were mixed until uniform and smooth.

Sample 1 constitutes a positive control gravy comprising titanium dioxide. Sample 2 constitutes a negative control gravy that does not comprise titanium dioxide or sweet corn flour. Samples 3 uses 1% non-clarified sweet corn flour. Samples 4 and 5 use 3% non-clarified sweet corn flour. In sample 4 the sweet corn flour is added to the dry ingredients. In sample 5 the sweet corn flour is dispersed in the beef broth mixture before solids and water were added.

The color of the gravies was measured using a colorimeter and are reported using the Hunter L, a and b values. The colorimetry results are reported in Table 2.

TABLE 2
Color Analysis of Brown Gravy (Varying Sweet Corn Flour)

| | Colorimeter | | |
|---|---|---|---|
| Sample | L | a | b |
| Sample 1 | 34.18 | 5.90 | 8.83 |
| Sample 2 | 27.13 | 2.08 | 2.25 |
| Sample 3 | 29.01 | 3.19 | 3.99 |
| Sample 4 | 32.10 | 4.87 | 6.45 |
| Sample 5 | 32.55 | 5.12 | 6.95 |

As seen, all samples using sweet corn flour had higher L, a and b values than the negative control, Sample 2, and had L, a, and b values closer to the Sample 1, using titanium dioxide. More specifically the values indicate that brown gravy samples using sweet corn flour or titanium dioxide are lighter, redder and more yellow than Sample 2, which did not use sweet corn flour or titanium dioxide.

Applicants also made a brown gravy using 1% clarified sweet corn flour (less than 9% sweet corn protein and greater than 85% soluble corn flour starch), called Sample 3a. Sample 3a had Hunter L, a and b values respectively of 28.68, 2.61 and 3.28. Sample 3a (clarified sweet corn flour) had Hunter L, a and b values like those Sample 3 (non-clarified sweet corn flour).

### Example 2— Varying Amounts of Inhibited Starch in Brown Gravy Using Sweet Corn Flour as a TiO₂ Replacement

Brown Gravy Samples 3, 4, and 5, using sweet corn flour, were thicker than Sample 1, using titanium dioxide. Applicants evaluated the effect of adjusting the amount of thermally inhibited starch used on viscosity and coloration of a brown gravy. Formulas of a brown gravies using different amounts of inhibited starch are reported in Table 3.

TABLE 3
Brown Gravies Formulas Using Sweet Corn Flour
to Replace TiO₂ and Having Different Amounts
of Inhibited Starch to Adjust Viscosity

| | Sample 1 | Sample 6 | Sample 7 |
|---|---|---|---|
| INGREDIENTS | wt. % | wt. % | wt. % |
| Beef broth* | 66.0 | 66.0 | 66.0 |
| TiO₂ (10% | 0.15 | | |
| solution) | | | |
| Thermally | 4.0 | 5.0 | 3.0 |
| inhibited Starch | | | |
| Extra fine sugar | 1.0 | 1.0 | 1.0 |
| Herb-Ox Beef | 2.0 | 2.0 | 2.0 |
| Flavor | | | |
| Caramel Color | 0.4 | 0.4 | 0.4 |
| Onion Powder | 0.25 | 0.25 | 0.25 |
| Paprika | 0.2 | 0.2 | 0.2 |
| Sweet Corn Flour | | | 3.0 |
| (non-clarified) | | | |
| Water | 25.0 | 24.15 | 21.15 |
| Butter | 1.0 | 1.0 | 1.0 |
| | 100 | 100 | 100 |

Sample 1 is the same gravy using titanium dioxide as described in Example 1. It uses 4% (by weight of the gravy) of a thermally inhibited starch. Sample 6 is a gravy that does not use sweet corn flour or titanium dioxide. Sample 6 uses 5% (by weight of the gravy) thermally inhibited starch. Sample 7 uses 3% non-clarified soluble corn flour (by weight of the gravy) and 3% thermally inhibited starch. The gravies were made using the method described in Example 1. The viscosity of the gravies and their Hunter L, a and b values are reported in Table 4.

TABLE 4
Hunter L, a and b, and Viscosity of Brown Gravy
using Different amounts of Inhibited Starch.

| | Viscosity @ | Colorimeter | | |
|---|---|---|---|---|
| Sample | serving temp (cP) | L | a | b |
| Sample 1 | 1160 | 44.55 | 4.04 | 12.81 |
| Sample 6 | 2920 | 36.26 | 2.82 | 8.20 |
| Sample 7 | 1160 | 50.17 | 3.69 | 13.43 |

As seen Sample 7, using less thermally inhibited starch than Sample 1, had the same measured viscosity as Sample 1 and had comparable color profile. This shows that the coloring from the sweet corn flour is distinct from the viscosity of the brown gravy and that sweet corn flour can be used to effectively replace titanium dioxide in food formulations, and that the formulations can be modified to match viscosity of their titanium dioxide analogs.

### Example 3— Mozzarella-Style Cheese Analog

Use of non-clarified sweet corn flour to replace titanium dioxide in solid systems was explored using an analog mozzarella style cheese. The formula for the analog mozzarella style cheese is reported in Table 5.

TABLE 5
Analog Mozzarella Style Cheese Formula

| | Sample 8 | Sample 9 | Sample 10 | Sample 11 | Sample 12 |
|---|---|---|---|---|---|
| Ingredient | (wt. %) | (wt. %) | (wt. %) | (wt. %) | (wt. %) |
| Water | 49.92 | 49.82 | 46.92 | 48.42 | 49.92 |
| Palm oil | 27.03 | 27.03 | 27.03 | 27.03 | 27.03 |
| Oxidized potato | 5.97 | 5.97 | 5.97 | 5.97 | 5.97 |
| starch | | | | | |
| Pregelatinized | 5.42 | 5.42 | 5.42 | 3.92 | 2.42 |
| Tapioca Flour | | | | | |
| Hydrolyzed waxy | 7.00 | 7.00 | 7.00 | 7.00 | 7.00 |
| corn starch | | | | | |
| Hydrolyzed | 2.15 | 2.15 | 2.15 | 2.15 | 2.15 |
| potato starch | | | | | |
| Native waxy | 1.00 | 1.00 | 1.00 | 1.00 | 1.00 |
| potato starch | | | | | |
| Gum mixture | 0.20 | 0.20 | 0.20 | 0.20 | 0.20 |
| (xanthan & | | | | | |
| locust bean) | | | | | |
| Salt | 1.20 | 1.20 | 1.20 | 1.20 | 1.20 |
| Potassium Sorbate | 0.11 | 0.11 | 0.11 | 0.11 | 0.11 |
| TiO₂ | 0.00 | 0.10 | 0.00 | 0.00 | 0.00 |
| Sweet corn flour | 0.00 | 0.00 | 3.00 | 3.00 | 3.00 |
| Total | 100 | 100 | 100 | 100 | 100 |
| Moisture | 52.69 | 52.60 | 50.05 | 51.37 | 52.69 |

Sample 8 is a negative control having no titanium dioxide or sweet corn flour. Sample 9 is a positive control using 0.10% titanium dioxide (wt. %) and a corresponding reduction in water usage compared to Sample 8. Samples 10 to 12 use 3% sweet corn flour (wt. %). The difference in solids usage between sweet corn flour and titanium dioxide required adjusting the formulas to compensate. Sample 10 reduced water content by 3% (wt. %) compared to Sample 8. Sample 11 reduced water content by 1.5% (wt. %) and pregelatinized tapioca starch (wt. %). Sample 12 reduced water content by 0.10% (wt. %), which matches Sample 9, and Sample 12 reduces pregelatinized tapioca by 3% (wt. %).

Analog cheese samples 8 through 12 were made as follows. All ingredients except water and palm oil were dry ingredients and were mixed by shaking in a zip-lock bag and shaken. Added water to Thermomix that was set to 37° C. and to speed 2.5. Dry ingredients were then slowly and mixed for 2 minutes. Melted palm oil in the microwave and add to the Thermomix slowly. Continued mixing at speed 2.5 for 3 minutes to form emulsion. Heated to 80° C. (heat setting 90° C.) at speed 2.5. Once the temperature of the sample reached 80° C., reduced to speed 2 and reduced the temperature setting to 80° C. Held for 7 minutes at speed 2. Mixture is poured into molds and refrigerated at about 4° C. for at least 48 hours before shredding.

Analog cheese samples were prepared as follows. Analog cheese was refrigerated at 4° C. for two weeks, before preparing samples. Samples were obtained for texture analysis by first slicing analog cheese into 17-18 mm slice, obtaining a cores from slice using a 39.5 mm diameter cheese borer. Samples for color analysis of melted cheese were obtained by shredding from analog blog using common cheese. Melt spread samples were obtained from by slicing 5 mm cross-sections from the 39.5 mm diameter cheese borer samples. After prep, all samples further refrigerated until analyzed.

Cheese Borer samples were analyzed for texture using a TAXT II Plus texture analyzer, set to 8 mm per second pre-test and post-test speed, probe was set to travel 10 mm distance over 2 seconds and registered with a 10 g trigger force). Samples were measured for hardness, cohesiveness, and chewiness. Test was run in duplicate. Results are reported in Table 6.

TABLE 6
Texture Analysis of Analog Mozzarella-style Cheese

| | Hardness | Firmness | Fracturability | Cohesiveness | Chewiness |
|---|---|---|---|---|---|
| Sample 8 | 4119 | 4762 | 901 | 203 | 494 |
| Sample 9 | 4470 | 5324 | 926 | 28 | 470 |
| Sample 10 | 5307 | 6507 | 979 | 9 | 407 |
| Sample 11 | 4068 | 5068 | 729 | 81 | 297 |
| Sample 12 | 3093 | 3771 | 581 | 166 | 239 |

Refrigerated samples were analyzed for color using a colorimeter using Hunter scale L, a and b, and yellowness index (“YI”). Measurements were made on the unmelted block of analog cheese and analog cheese melted phase, from shredded analog mozzarella style cheese. Table 7 reports the color values of the unmelted and melted analog mozzarella style cheese.

TABLE 7
Color Analysis of Block and Melted
Analog Mozzarella Style Cheese

| | Block | | | | Melt | | | |
|---|---|---|---|---|---|---|---|---|
| | L | A | b | YI | L | A | B | YI |
| Sample 8 | 81 | −1.27 | 7.86 | 16.09 | 51 | −0.92 | 3.17 | 9.56 |
| Sample 9 | 81 | −1.09 | 7.28 | 15.13 | 68 | −1.84 | 4.98 | 10.96 |
| Sample 10 | 81 | −0.38 | 7.47 | 16.21 | 65 | −1.26 | 9.67 | 25.06 |
| Sample 11 | 81 | −0.39 | 7.50 | 16.28 | 67 | −1.19 | 9.45 | 23.82 |
| Sample 12 | 81 | −0.57 | 7.23 | 15.54 | 67 | −1.41 | 9.80 | 24.69 |

As seen in Table 8, in block form, all samples had comparable color with all samples having similar lightness and yellow index. In melted form, sample 8 having no titanium dioxide or sweet corn lower being darker than Sample 9 to 12 (having either titanium dioxide or sweet corn flour). This shows sweet corn flour is a useful replacement titanium dioxide in both unmelted and melted analog mozzarella style cheeses in terms of color profile.

Samples were tested for melting properties by placing samples (39.5 mm diameter, 5 mm depth) in an oven safe dish. Horizontal and vertical diameters of the samples were measured, and the sample was heated for five minutes in an oven preheated to 450° F. (232° C.). Samples were cooled for 5 minutes and the vertical and horizontal diameter of the melted disc was measured. % melt spread was calculated and is reported in Table 8.

TABLE 8
% Melt Spread of Analog Mozzarella-style Cheese

| | % Melt Spread |
|---|---|
| Sample 8 | 58% |
| Sample 9 | 54% |
| Sample 10 | 10% |
| Sample 11 | 35% |
| Sample 12 | 39% |

As seen in Tables 6 to 8, sweet corn flour can be used to replace the color profile provided by titanium dioxide and can be reformulated to provide make an analog mozzarella-style cheese having textural properties like a titanium dioxide control.

### Example 4—Use of Sweet Corn Flour as an Opacifier in a Model Low-Fat Bechamel-Style Sauce

Use of sweet corn flour as an opacifier was further evaluated in a low-fat Bechamel-style sauce. Table 9 provides the compared formulas. Sample 13 is a full-fat Bechamel-style sauce (using whole milk); Sample 13 does not include sweet corn flour. Sample 14 is a low-fat Bechamel-style sauced (using skim milk); Sample 14 does not include sweet corn flour. Sample 14 is a low-fat Bechamel-style sauce including non-clarified sweet corn flour.

TABLE 9
Formula Bechamel-style Sauce

| Ingredient (grams) | Sample 13 | Sample 14 | Sample 15 |
|---|---|---|---|
| Whole milk | 1354.5 | 0 | 0 |
| Skim milk | 0 | 1347 | 1309 |
| Butter | 75 | 75 | 75 |
| Salt | 4.5 | 4.5 | 4.5 |
| Thermally inhibited | 66 | 73.5 | 66 |
| waxy corn starch | | | |
| Sweet Corn Flour | 0 | 0 | 45 |
| (non-clarified) | | | |

Sauce was made as follows. Starch, flour (if used), and salt were blended (dry) and then mixed with milk. Slurry was mixed and heated for 15 minutes using a Thermomix mixer set to 90° C. and speed of 1.5. Butter was melted into slurry when 5 minutes are left on cook time.

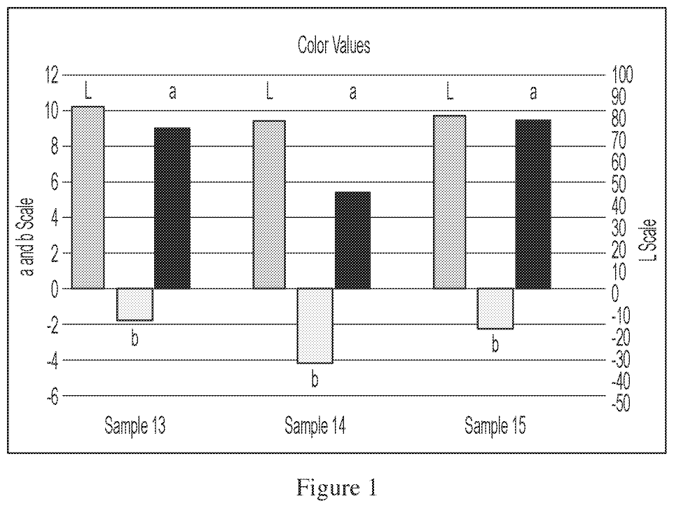

Color profile (L, a, and b) of sauces was measured using Hunter colorimeter. Results are provided in FIG. 1. Comparing Samples 13 (using whole milk but no sweet corn flour) and 14 (using skim milk but no sweet corn flour) Sample 14, is darker (lower lightness value (L)) and has different hue (different a and b values). Sample 15 (using skim milk and sweet corn flour) more closely matches the color of Sample 13, having higher L, a, and b values than Sample 14 (i.e. Sample 15's values are more positive and less negative on the integer series).

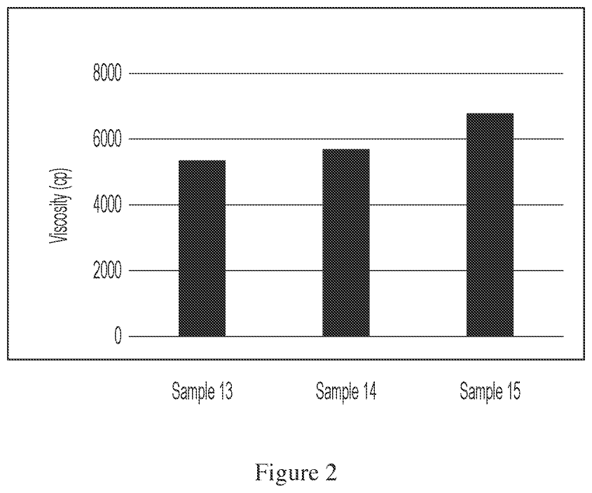

The viscosity of the samples is reported in FIG. 2, which shows that all samples have comparable viscosity in a range between about 5000 cP (Sample 13) and about 7000 cP (Sample 14)

What is claimed is:

1. A pregelatinized sweet corn flour comprising: soluble starch in an amount of at least about 65% wherein.

2. The sweet flour of claim 1 having a protein content of at least about 5% by weight of the flour.

3. The sweet flour of claim 1 having an insoluble starch content of less than about 5% by weight of the flour.

4. The sweet flour of claim 1 having a mean particle size of a particle size distribution of from 100 to 200 nm.

5. The sweet flour of claim 1 having a polydispersity index greater than 0.35.

6. A composition comprising:
a. a moisture content of at least about 30% by weight of the composition; and
b. a sweet corn flour in an amount of from about 1% to about 6% by weight of the composition
wherein the composition has a Hunter L value of at least about 30.

7. The composition of claim 6 wherein the sweet flour is clarified sweet corn flour.

8. The composition of claim 6 further comprising a second starch, which is from a source other than sweet flour
wherein the second starch is from a source selected from the group consisting of: corn, waxy corn, tapioca, waxy tapioca, potato waxy potato, rice waxy rice, pea, and mixtures thereof.

9. (canceled)

10. The composition of claim 6 further comprising a second plant protein, which is from a source other than sweet flour, in an amount from about 5% to about 20% by weight of the composition.

11. The composition of claim 6 wherein the composition does not comprise titanium dioxide or calcium carbonate.

12. The composition of claim 6 wherein the composition is selected from the group consisting of: imitation cheese, a vegan cheese analog, a frozen dessert, an ice cream, a dairy-free ice cream-analog, a frozen sauce, beverages, sauces, gravies, yogurts, alternative yogurts, alternative dairy beverages, and non-dairy creamers.

13. The composition of claim 6 being a flowable edible composition wherein
the moisture content is greater than about 60%; and
the sweet corn flour in an amount of from about 1% to about 6% by weight of the composition,
the composition is selected from the group consisting of beverages, sauces, gravies, yogurts, alternative yogurts, alternative dairy beverages, and non-dairy creamers

14. (canceled)

15. The composition of claim 6 being a flowable composition and further comprising a second starch wherein the second starch is a native starch

16. The composition of claim 6 being a flowable edible composition and further comprising a
a. wherein the second starch is a modified starch

17. (canceled)

18. (canceled)

19. (canceled)

20. (canceled)

21. The composition of claim 6 being a meltable edible composition wherein
the composition has a moisture content of 30% to 60%, and
the composition has a sweet corn flour in an amount of from about 1% to about 6% by weight of the composition.
is selected from the group consisting of an imitation cheese, a vegan cheese analog, a frozen dessert, an ice cream, a dairy-free ice cream-analog, a frozen sauce.

22. The composition of claim 6 wherein the composition is a meltable editable composition further comprising a second starch, which is from a source other than sweet flour, wherein the second starch is in an amount from about 10% to about 35% (by weight of the composition).

23. (canceled)

24. (canceled)

25. The composition of claim 6 wherein the composition has a % melt spread of at least about 25%,

26. The composition of claim 6 wherein the composition is a meltable composition that has a Hunter L value of greater than about 55 when melted.

27. (canceled)

28. (canceled)

29. (canceled)

30. A method of making a composition comprising: mixing a sweet corn flour and a second ingredient.
